(19) United States
(12) Patent Application Publication
(10) Pub. No.: US 2024/0183387 A1
(43) Pub. Date: Jun. 6, 2024

(54) Axial-Radial Sliding Bearing

(71) Applicant: igus GmbH, Köln (DE)

(72) Inventors: Ralf Selzer, Lohmar (DE); David Szepokat, Köln (DE)

(21) Appl. No.: 18/286,111

(22) PCT Filed: Apr. 12, 2022
(86) PCT No.: PCT/EP2022/059753

§ 371 Date: Dec. 20, 2023

(30) Foreign Application Priority Data
Apr. 12, 2021 (DE) 20 2021 101 947.6
Oct. 1, 2021 (DE) 10 2021 125 527.9

(51) Int. Cl. F16C 17/10; F16C 33/20; F16C 41/00

(52) U.S. Cl. CPC F16C 17/10; F16C 33/20; F16C 41/001; F16C 2226/76

(57) ABSTRACT

an axial-radial sliding bearing (1) includes a first bearing ring (2) and a second bearing ring (4), the bearing rings being rotatable in relation to one another about a bearing axis A, and the second bearing ring (4) forming a substantially U-shaped cross-section in order to accommodate at least portions of the first bearing ring; and sliding elements (6) which are made of a polymer material and are arranged between the first and the second bearing ring in order to axially and radially decouple the bearing rings, the sliding elements (6) each having a substantially L-shaped cross-section with an axial region including axial sliding faces, and a radial region including radial sliding faces. At least one of the two bearing rings has a seat (7) for a detent element (8) which is accommodated therein, is force-loaded and deflectable, and the other of the two bearing rings has at least one detent recess (9) associated with the detent element for accommodating at least portions of the deflectable detent element (8) so as to provide a releasable locking action at a specified relative rotational position of the two bearing rings (2, 4) in relation to one another.

The invention relates to an axial-radial sliding bearing, in particular a slewing ring bearing, comprising a first bearing ring and a second bearing ring, the bearing rings being arranged rotatably against each other about a bearing axis and the second bearing ring forming a substantially U-shaped cross-section in order to accommodate the first bearing ring at least in sections, further comprising sliding elements of a polymeric material arranged between said first and second bearing rings to decouple said bearing rings axially and radially, said sliding elements each having a substantially L-shaped cross-section with an axial region comprising axial sliding surfaces and a radial region comprising radial sliding surfaces.

Such axial-radial sliding bearings are designed to support both axial and radial forces and are used, for example, for rotary indexing tables, dividing apparatuses, for the design of CNC rotary axes and for the mounting of swiveling screens, etc. A tribologically suitable polymer can be used as the polymer material for manufacturing the sliding elements, which polymer material can usually be applied without lubricants.

A generic axial-radial sliding bearing is described, for example, in the utility model specification DE 20 2013 101 374 U1. The advantages of such conventional sliding bearings can be seen in particular in the low friction of the bearing rings relative to each other, maintenance-free operation, low-cost manufacture and robust design and high wear resistance. Since in addition to radial and axial loads, tilting moment loads on the bearing point can also be reliably absorbed despite the small construction size, these conventional axial-radial sliding bearings considerably reduce the effort and thus the costs involved in designing connecting structures and installing the bearings. The multitude of these advantages has resulted in the widespread use of such polymer slewing ring bearings (PRTs) in a wide variety of fields.

In a plurality of applications of such sliding bearings, the task may be to approach and fix a predetermined relative rotational position of the two bearing rings with respect to each other with recurring precision when carrying out a rotational movement of the two bearing rings with respect to each other, for example when used on an assembly table.

Therefore, the present invention is based on the problem of further developing a conventional axial-radial sliding bearing in such a way that a relative rotational position of the two bearing rings of the sliding bearing to each other can be reliably and reproducibly approached without the need for a high additional design effort, starting from a conventional axial-radial sliding bearing, and without this additional functionality being accompanied by the need for increased installation space for the sliding bearing.

The present invention already solves this problem with an axial-radial sliding bearing comprising the features of claim 1. The axial-radial sliding bearing according to the invention has a first bearing ring and a second bearing ring, the bearing rings being arranged rotatably against each other about a bearing axis, and the second bearing ring forming a substantially U-shaped cross-section in order to accommodate the first bearing ring at least in sections, further comprising sliding elements of a polymer material which can be used for tribological purposes, which sliding elements are arranged between the first and second bearing rings in order to decouple the bearing rings axially and radially, i.e., to reduce the friction between the bearing rings. i.e., to reduce the friction of the bearing rings in the axial and radial directions relative to each other, the sliding elements each having a substantially L-shaped cross-section with an axial region comprising axial sliding surfaces and a radial region comprising radial sliding surfaces. The axial-radial sliding bearing according to the invention is characterized in that at least one of the two bearing rings has a seat for a deflectable detent element which is accommodated therein and can be subjected to force, and the other of the two bearing rings comprises at least one detent recess associated with the detent element for accommodating at least portions of the deflectable detent element so as to provide a releasable locking action at a specified rotational position of the two bearing rings in relation to each other.

The axial-radial sliding bearing according to the invention is based on the basic idea of designing the relative arrangement of the two bearing rings to each other in such a way that at least two operating situations or operating positions of the two bearing rings to each other can be provided, namely a first one, in which the two bearing rings are arranged freely rotatable relative to each other about the bearing axis, and at least a second one, with a predetermined relative rotational position of the first and second bearing ring to each other, in which the relative movement of the two bearing rings to each other is blocked, in which case, however, this blockage can be released or removed again by applying a predetermined release torque or a release force. According to the invention, this blockage of movement of the two bearing rings relative to each other is provided by a releasable locking action of the two bearing rings relative to each other. By providing a force-actuated detent element on one of the two bearing rings, which cooperates with an associated detent recess on the other bearing ring to releasably block the relative rotation of the two bearing rings with respect to each other, the desired functionality can be provided without requiring special structural designs that would otherwise increase the overall volume of the bearing. The described locking action of the two bearing rings with respect to each other occurs after the adjustment of the at least one predetermined relative rotational position between the two bearing rings, at which the detent element is moved into the at least one detent recess as a result of the application of force and thus comes into engagement with the associated detent recess.

The designation of surfaces of the sliding bearing according to the invention or of its components as axial surfaces or radial surfaces means surfaces that are substantially perpendicular to the axial direction or radial direction of the bearing. L-shaped with respect to the shape of the sliding elements can mean a design in which the respective sliding elements have axial and radial sliding surfaces which can be oriented at about 90° to each other. In this case, the extension dimension of the axial sliding surfaces in the radial direction may be greater than the extension dimension of the radial sliding surfaces in the axial direction of the bearing. However, the term “L-shaped” sliding elements also covers embodiments in which the extension dimension of the axial sliding surfaces in the radial direction is smaller than or equal to the extension dimension of the radial sliding surfaces in the axial direction of the bearing.

Further developments of the invention as well as additional features according to the invention are stated in the general description, the figures, the description of the figures as well as the subclaims.

Expediently, it may be provided that the complementary detent means provided on both bearing rings are arranged on opposing surfaces of the two bearing rings so that they are configured for releasably blocking the relative rotational movement of the two bearing rings to each other.

According to the invention, the detent element and detent recess configured to cooperate and complement each other may be arranged on mutually facing interfaces of the two bearing rings. In an expedient embodiment, it can be provided that the detent element and the at least one detent recess are arranged on respective mutually facing radial surfaces of the one and the other bearing ring. It may be provided that the detent element arranged in the seat of one bearing ring is acted upon by force in the radial direction and is arranged to be deflectable in order to provide a locking action of the two bearing rings relative to each other in the radial direction when setting a predetermined relative rotational position of the two bearing rings to each other. However, it is also possible to provide that the detent element and the at least one detent recess are arranged on mutually facing axial surfaces of the one and the other bearing ring respectively and that the detent element arranged in the seat of the one bearing ring is acted upon by force in the axial direction and can be deflected. Furthermore, it is also possible that a detent element and at least one associated detent recess are arranged on respective mutually facing radial surfaces of the one and the other bearing ring and, at the same time, a further detent element and at least one detent recess associated therewith are arranged on respective mutually facing axial surfaces of the one and the other bearing ring, so that a locking action of the two bearing rings to each other can take place both on the mutually facing axial surfaces and on the mutually facing radial surfaces.

It may be expedient to provide that the seating area for receiving the force-loaded and deflectable detent element on one of the bearing rings is designed to be free of sliding elements in order to provide the desired locking action. It can be provided that in the region of the detent element seat on one of the two bearing rings on the axial surface none or no section of the L-shaped sliding elements is provided, but at least one other sliding element which extends alone in the axial surface or provides alone an axial surface in such a way that the radial deflection of the detent element during the locking action is not impeded by this sliding element. In particular, it can be provided that no sliding element or no section of a sliding element is arranged in the region of the seat of the detent element on the radial surface of one of the two bearing rings.

The design of the bearing according to the invention may be such that the release torque for releasing the engagement of the two bearing rings with respect to each other can be generated by applying a predetermined torque to one of the bearing rings, while the other bearing ring is held stationary, this predetermined torque representing a torque threshold from which the locking action can be released. For this purpose, the detent element can be designed with a corresponding curved detent surface. It is expedient to provide that the detent element has, at least in sections, a spherical or cylindrical detent surface which in a detent posture or detent position of the detent element corresponds to the at least one associated detent recess with a complementary detent surface of this detent recess. In this respect, the term detent surface means contact surface of the detent element or of the associated detent recess. Due to the described curved design of the detent surfaces or contact surfaces, the desired releasability of the locking can be provided in a simple manner. By means of a corresponding design of the detent surfaces of the detent element and the detent surfaces of the detent recess associated with the detent element, it can be provided that the release torque is set differently depending on the direction of rotation of the two bearing rings to each other, which can be expedient in certain applications.

For the design of the second bearing ring with a substantially U-shaped cross-section, it can be provided that the latter has two axially spaced ring sections which are connected by an axial flange for creating a receptacle in which the first bearing ring is arranged at least in sections between these two axially spaced ring sections of the second bearing ring. Depending on the embodiment, the axial flange can be arranged radially on the inside or radially on the outside of the two axially spaced and generally coaxially aligned ring sections. Depending on the application, embodiments in which the axial flange of the second bearing ring is arranged radially on the inside of the two axially spaced ring sections are particularly expedient, so that the outer radial surface of the first bearing ring, which is received in sections by the second bearing ring, is exposed and can comprise a functional surface, for example a functional surface of a gearwheel.

According to the invention, the detent element can be formed in one or more pieces. In particular, this can be formed in one piece as a pin element, for example as a cylindrical pin element. In this case, the length of the detent element, which corresponds to an associated detent recess on the other bearing ring, can be set to define a predetermined release torque at which a set detent position between the two bearing rings of the axial-radial sliding bearing according to the invention can be released. In such embodiments, in which the detent element may be formed as a cylindrical pin element, the associated detent recess may correspond to a partial volume of the cylindrical volume of the pin element, which partial volume may have a dimension of extension in the axial direction of the bearing substantially equal to that of the cylindrical detent element.

It may be provided that the longitudinal extent (axial extent) of the detent element is more than half the axial extent of the bearing ring having the smallest axial extent. In a particularly useful embodiment, it may be provided that the axial extent of the detent element substantially corresponds to the axial extent of the radial flange of the second bearing ring, so that the locking action of the two bearing rings can be provided over the entire axial extent of the radial flange. For this purpose, it can be provided that the axial extension of the associated detent recess corresponds to the axial dimension of the detent element, so that the described locking effect between the detent element and the detent recess is present over its entire extension after the setting of a predetermined relative rotational position between the two bearing rings, at which the force-loaded detent element comes into engagement with the associated detent recess.

To provide a force application to the detent element, for example, a clamping element, in particular in the form of a screw element, can be provided that presses on the detent element, in particular an elastically deformable detent element, and generates an elastic reaction force with which the detent element plunges into the associated detent recess for locking when a predetermined relative rotational position of the two bearing rings to each other exists.

In another embodiment, a spring device, in particular in the form of a spiral spring, can be provided, which can be arranged in a bore, for example a radial bore, of the one bearing ring and is clamped between the detent element and a radial stop element such as a screw. Preferably, it may be provided that the longitudinal axis of the spiral spring is oriented approximately perpendicular to a longitudinal axis of the detent element.

In particular, in order to provide a plurality of relative rotational positions of the two bearing rings with respect to each other and thus a plurality of assembly positions when designing an assembly table, it can be expediently provided that the other of the two bearing rings has a plurality of circumferentially spaced detent recesses for successively receiving the detent element when the two bearing rings are rotated to each other.

In order to provide the most wear-free operation possible of the axial-radial sliding bearing according to the invention, it can be expediently provided that the seat for the detent element on one of the two bearing rings is designed to receive the detent element substantially completely in relative operating postures or operating positions of the two bearing rings to each other outside a detent position. Furthermore, this construction can provide an arrangement of the two bearing rings to each other that is as free of play as possible.

Generally, the arrangement of the seat of the detent element can be provided on the second bearing ring or the first bearing ring and, in a corresponding manner, the arrangement of the associated at least one detent recess can be provided on the second bearing ring or the first bearing ring. In such embodiments, in which the axial flange of the second bearing ring is provided radially inwardly for connecting the two axially spaced ring sections, the at least one detent recess can expediently be arranged on the second bearing ring, in particular on the axial flange of the second bearing ring, and the seat of the detent element on the first bearing ring. This embodiment has in particular the advantage that the element for applying force to the detent element is accessible from radially outside, which can facilitate possible maintenance of the bearing.

In the design of the sliding bearing according to the invention it can be provided that, in order to disengage the two bearing rings from each other, they are not separated by applying a predetermined torque to one of the bearing rings, but by providing and actuating a corresponding actuating device with which the detent element can be disengaged from the at least one detent recess. In this connection, the actuating device may be arranged on the one of the two bearing rings, and it may have an actuating section which is movable relative to this bearing ring and is in operative connection with the detent element. In particular, it may be provided that the actuating section is arranged motion-coupled to the detent element, wherein this motion coupling may be realized in the manner of a coupling with respect to a linear motion of actuating section and detent element in the ratio of 1:1, but need not be. Instead, the motion coupling may also provide for and be established with a reduction or transmission of the motion, optionally also with a change in direction between the actuating section and the detent element.

Expediently, it can be provided that the locking action by engagement of the detent element with the at least one associated detent recess provides such a form closure between the first and second bearing rings that this cannot be released non-destructively without actuation of the actuating device, even when a high torque is applied to one of the bearing rings. It can be expediently provided that the detent element in the locked state engages in the at least one associated detent recess over a predetermined radial extent, and mutually associated detent surfaces on the detent element as well as the detent recess are designed in such a way that, when a torque is applied to one of the bearing rings, no or only a small force component can be generated on the detent element, which force component presses the detent element out of the detent recess against the application of force. For example, in one embodiment, it can be provided that the at least one detent recess is formed by flat surfaces, while the detent element has flat interfaces in the region of engagement with the detent recess. In one embodiment, it may also be provided that the detent element is cylindrical in shape, wherein the cylinder axis may be oriented in particular radially with respect to the one of the bearing rings on which the seat of the detent element is arranged.

Also in the embodiment of the axial-radial sliding bearing according to the invention which has an actuating device as described, it can be provided for designing the second bearing ring with a substantially U-shaped cross-section that the latter has two axially spaced ring sections, which are connected by an axial flange, for designing a receptacle in which the first bearing ring is arranged at least in sections between these two axially spaced ring sections of the second bearing ring. Expediently, it can be provided that the axial flange of the second bearing ring is arranged radially inwardly of the two axially spaced ring sections, so that the outer radial surface of the first bearing ring received in sections by the second bearing ring is exposed and can have a functional surface on which, in particular, the actuating device can be arranged, which facilitates accessibility of the actuating section of the actuating device.

In general, the term “actuating section” of the actuating device designates a section engaged manually by a user or engaged by a controllable actuator of the actuating device, in particular to release the locking of the detent element and associated detent recess, wherein the actuating section can be arranged to be radially deflectable relative to one of the two bearing rings for this purpose.

In a particularly useful embodiment, it can be provided that a force-transmitting element, for example a traction and/or pressure means such as a Bowden cable or a rod-shaped element, is arranged between the operatively connected, in particular motion-coupled, detent element and actuating section. For example, by using such a force-transmitting element, an actuation of the actuating device can take place locally remote from the axial-radial sliding bearing according to the invention. In a particularly simply designed embodiment, it can also be provided that the detent element and the actuating section are integrally manufactured, in particular as one piece, with a force-transmitting element, such as a rod portion, possibly located therebetween.

For example, the integral component can be formed as a rod-shaped element that provides an actuating section at one end and the detent element at the other end. In this respect, in the present application, the term “element” is to be understood broadly and may also denote a section of a component. Further, a plurality of such elements or sections may be integrally formed as a single component.

In the embodiment of an axial-radial sliding bearing according to the present invention comprising such an actuating device, in order to apply a force to the detent element, the detent element may be arranged spring-loaded in such a way that the detent element engages in the at least one detent recess after setting a predetermined rotational position of the two bearing rings to each other. In particular, the actuating device can have a spring device, e.g. in the form of a spiral spring, which acts directly or indirectly on the detent element and is supported on a section fixed relative to one of the bearing rings, so that the detent element plunges into an associated detent recess for locking when a predetermined rotational position of the two bearing rings relative to each other exists. Due to the operative connection between the actuating section and the detent element, this spring-elastic preloading of the detent element can also be implemented by a corresponding spring device engaging at the actuating section and/or at the intermediate force-transmitting element.

Also in the design of an embodiment of an axial-radial sliding bearing according to the invention which has an actuating device for actuating the detent element, it can be expediently provided that, in order to provide an assembly table, a plurality of relative rotational positions of the two bearing rings to each other and thus a plurality of assembly positions are provided by the other of the two bearing rings having a plurality of circumferentially spaced detent recesses for successively receiving the detent element during a rotation of the two bearing rings to each other.

In order to prevent that after releasing the locking of the two bearing rings and the subsequent rotation of the bearing rings to each other, in particular in order to set a further assembly position, the detent element grinds against a radial surface of the other bearing ring after removal of an actuating force exerted on the detent element against the application of force at the actuating section, it can be expediently provided that the actuating device is arranged and designed for locking an operating position in which a locking of the detent element in the at least one detent recess is released, i.e., the engagement of the detent element in the at least one associated detent recess is removed by withdrawal of the detent element from the detent recess. This locking can, for example, take place in a force-locking manner, e.g. by a clamping action of the detent element, of the actuating section operatively connected to the detent element and/or of a force-transmitting element or section arranged between them. In another embodiment, it may also be provided that the actuating device is arranged and designed for positive locking of an operating position. For example, it can be provided that the actuating section, the detent element and/or a force-transmitting element or section arranged therebetween is arranged for a forcibly guided movement in the radial direction relative to one of the two bearing rings over a predetermined distance threshold to release the locking from a detent position of the detent element and is arranged for rotation about a radial direction after exceeding the threshold distance to set a radial positive locking between the actuating section, the detent element and/or a force-transmitting element or section arranged therebetween and the other of the bearing rings.

In a particularly expedient embodiment, it can be provided that the actuating device has an actuator, in particular of controllable design, which is configured to provide an actuating force or an actuating torque, in particular in such a way that manual actuation can be dispensed with, which facilitates handling of the sliding bearing according to the invention. Such an actuator may be an electric, pneumatic or hydraulic actuator and such an actuator is also referred to as an adjusting unit in that field.

It should be noted that in such embodiments in which the actuating device of the sliding bearing comprises a controllable adjusting unit, the detent element accommodated in the seat need not necessarily be arranged in a force-actuated manner, in particular in such embodiments in which the adjusting unit is of self-locking design. Such a sliding bearing can in this respect be designed like one of the sliding bearings described above, except for the fact that the detent element is not force-loaded, i.e. is arranged force-free, in a locked operating position and/or in an unlocked operating position, in which case this operating position can be held or fixed by the adjusting unit.

The adjusting unit can be designed to extend or retract a thrust tube linearly, in particular as an electric cylinder, pneumatic cylinder or hydraulic cylinder. Preferably, it can be provided that such an adjusting unit is motion-coupled on the output side to the actuating section of the actuating device, in particular is connected thereto for linear movement of the actuating section, or that the actuating section is an integral part of the adjusting unit. The use of an electric cylinder, which can in particular comprise a linear actuator including a motor and a spindle driven by this motor, can be based on a compact structure and permits simple integration into the arrangement of the first and second bearing ring according to the invention for designing an axial-radial sliding bearing according to the invention.

Expediently, it can be provided that the actuator or the adjusting unit is designed for setting at least two operating positions of the bearing rings relative to each other, namely a locked operating position in which the two bearing rings are locked relative to each other by the detent element engaging in a detent recess assigned to the detent element, and a released operating position in which the two bearing rings are arranged unlocked relative to each other by the detent element not engaging in any assigned detent recess. Such an actuator or actuating unit can be configured to be controllable, for example by the user causing a control signal, in particular an electrical control signal, to be sent to the actuator or actuating unit and thereby causing the actuator or actuating unit to change its operating position, in particular for a locking action or for releasing the locking of the two bearing rings to each another.

In a particularly useful embodiment, it can also be provided that the axial-radial sliding bearing according to the invention is prepared to connect an actuator selected by the user to the actuating device of the axial-radial sliding bearing according to the invention. For this purpose, it can be provided, for example, that the actuating section of the actuating device has a mechanical coupling device, such as a bolt thread or a female thread, for coupling to an actuating unit that can be configured on the output side with a coupling device of complementary design, i.e., in this case a female thread or a bolt thread, and can be coupled to the coupling device of the actuating device.

Adjusting or releasing a locking of the two bearing rings relative to each other or of the detent element in an associated detent recess can lead to wear at mutually associated detent surfaces in the course of operation of the sliding bearing, so that maintenance or replacement of predetermined components will become necessary after a predetermined operating period. For this purpose, the axial-radial sliding bearing according to the invention can have a monitoring device for detecting locking and/or non-locking states of the axial-radial sliding bearing. This monitoring device can, in particular, be integrated into the actuating device or into the actuator or the adjusting unit. The monitoring device may for example comprise an electrical contact which may in particular be motion-coupled to the actuating section and may, for example, be configured and arranged in such a way that the triggering of the contact indicates secure locking of the two elements to each other. For example, the electrical contact may comprise a fixed section and a section motion-coupled to the actuating section, the two sections of the contact being arranged to be movable towards each other by the movement of the actuating section until an electrical contact is made.

In one embodiment, it may also be provided that the monitoring device includes counting means for determining the number of locking/non-locking states set in operation, for example, to derive a wear indication therefrom. Furthermore, it can be provided that the monitoring device comprises a memory device for storing the determined number of locking/non-locking states, which can be read out, for example, by an external control device for estimating a wear condition and/or for determining a maintenance interval.

Expediently, the sliding elements can be formed as an injection-molded part, wherein a material thinning in the manner of a film hinge can be provided between the radial and axial sliding surfaces for bending the radial to the axial sliding surfaces by about 90°, so that with a single sliding element both a radial and an axial sliding surface of the axial-radial sliding bearing according to the invention are provided.

In order to facilitate in particular the assembly of the sliding bearing according to the invention, it can be expediently provided that a single sliding element comprises in the region of its axial sliding surface a plurality of first sectors arranged substantially without gaps and succeeding each other circumferentially in the installed position, i.e., in the assembled state of the bearing, in which case these sectors can be formed, for example, in a trapezoidal shape. Furthermore, it can be provided that the sliding element comprises in the region of its radial sliding surface a plurality of circumferentially spaced-apart and circumferentially successive sectors, so that the respective sliding element can be arranged in a circular manner such that the first sectors are arranged between mutually opposite axial interfaces of the first and second bearing rings and the second sectors are arranged between the mutually opposite radial interfaces of the first and second bearing rings. It may be particularly expedient to provide that at least two such sliding elements are included and are arranged such that they are axially offset with respect to their axial sliding surface by approximately the axial dimension of the first bearing ring and circumferentially offset with respect to each other by approximately half the circumferential dimension of the first sectors. In this way, it can be achieved that radially extending interfaces between first sectors and radially extending interfaces between the second sectors of the sliding elements are not circumferentially superimposed on each other, but are arranged offset from each other, which can increase the load capacity of the axial-radial sliding bearing according to the invention.

The invention is explained below by describing an embodiment together with variations with reference to the accompanying drawings, wherein

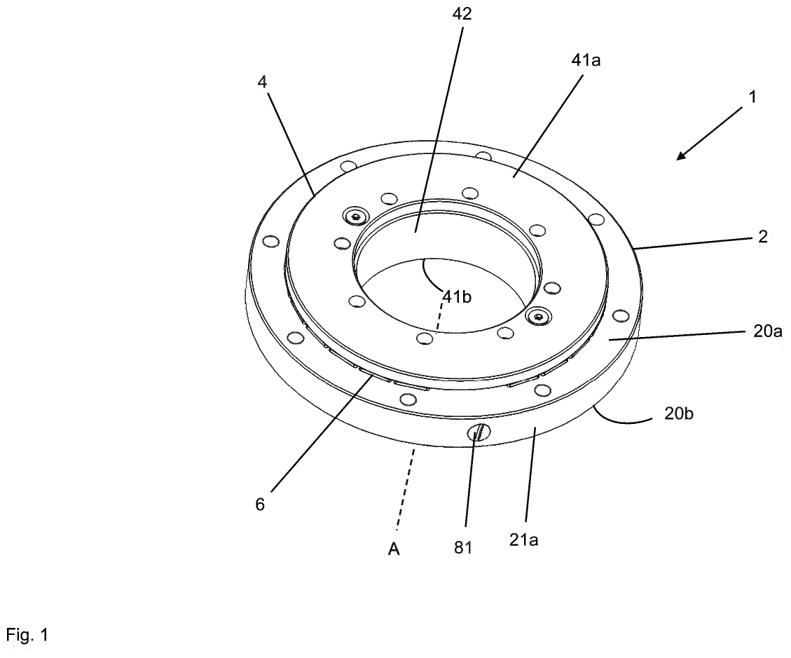

FIG. 1 is a perspective view of an axial-radial sliding bearing designed according to the invention,

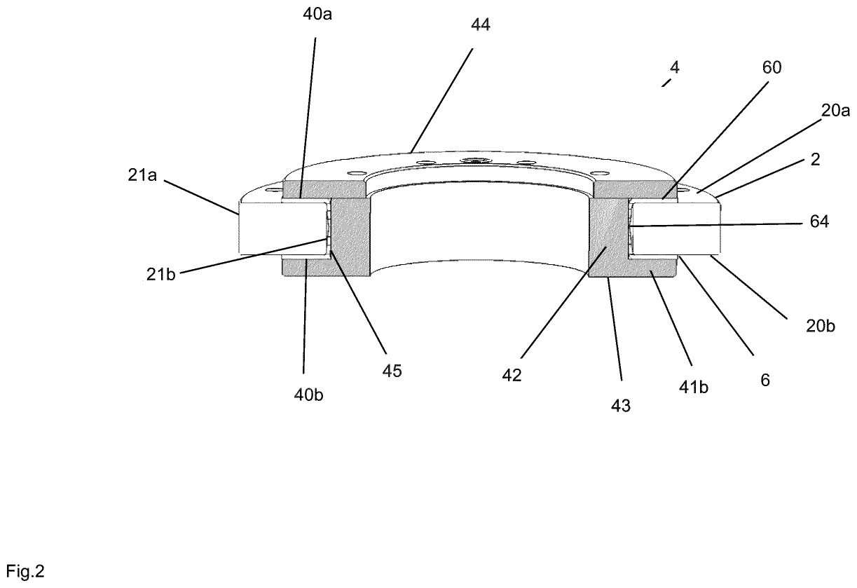

FIG. 2 shows a longitudinal section of the sliding bearing according to the invention shown in FIG. 1,

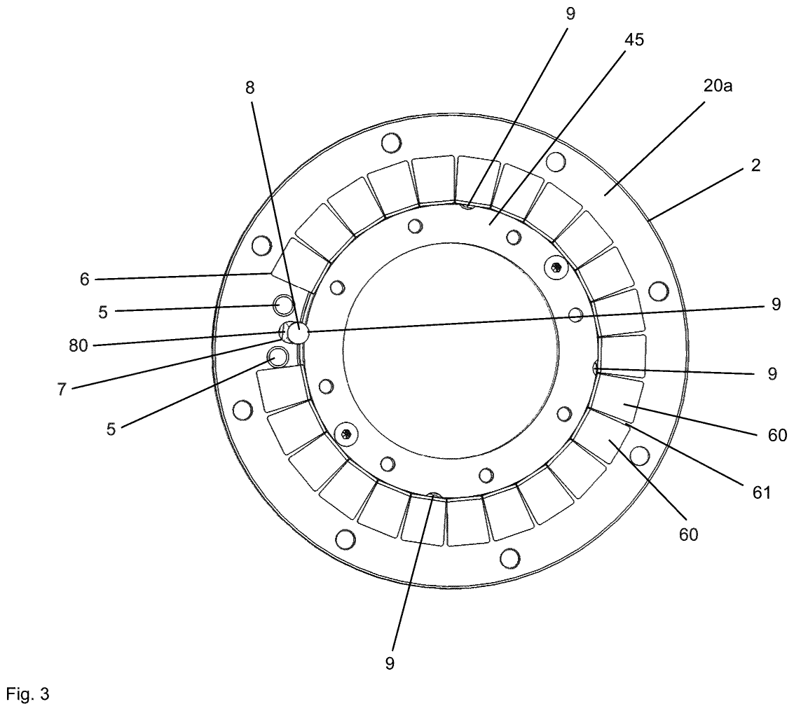

FIG. 3 shows the bearing according to the invention of FIG. 1 in a top view with a partial removal of the second bearing ring,

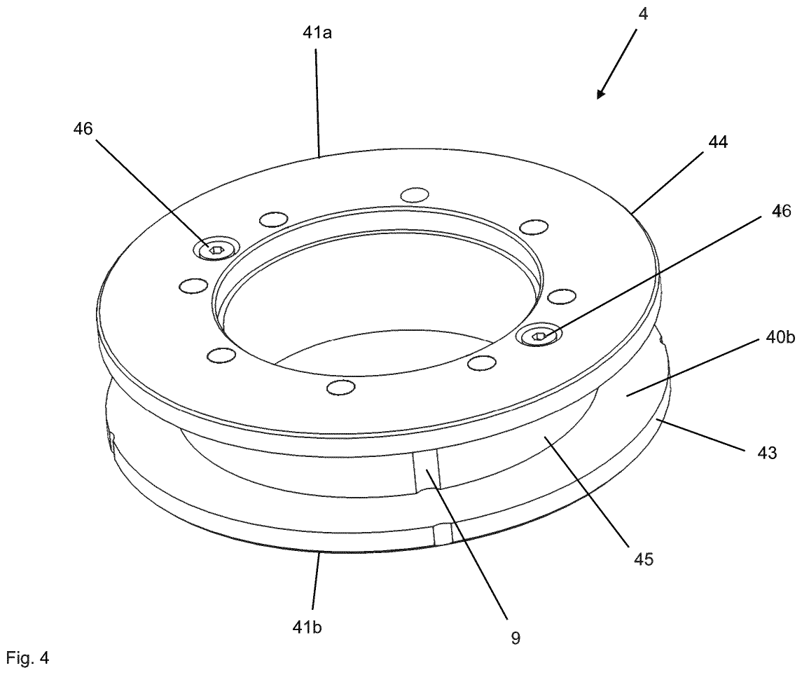

FIG. 4 shows the second bearing ring of the sliding bearing according to the invention of FIG. 1 in a perspective single view,

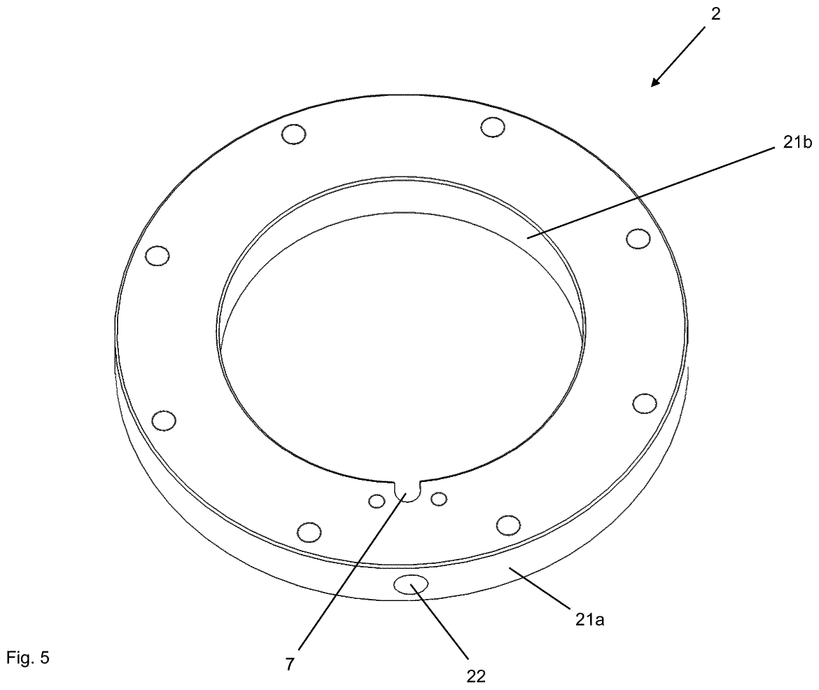

FIG. 5 shows the first bearing ring of the sliding bearing according to the invention of FIG. 1 in a perspective single view,

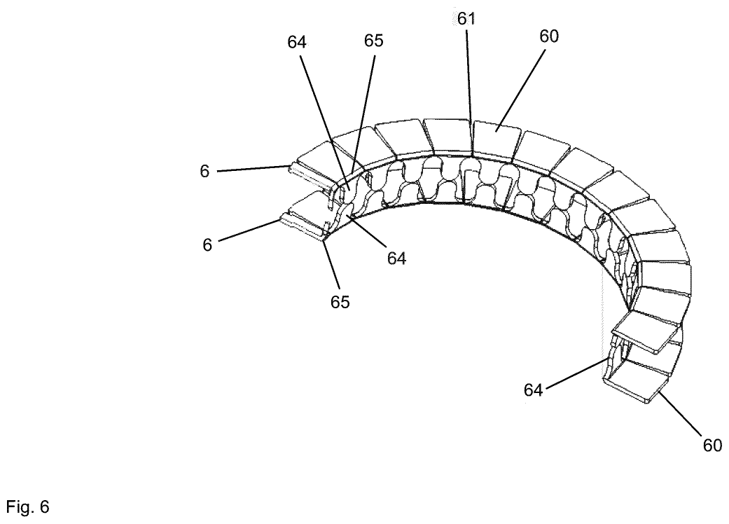

FIG. 6 is a partial view of the sliding elements of the sliding bearing according to the invention of FIG. 1 in a perspective view,

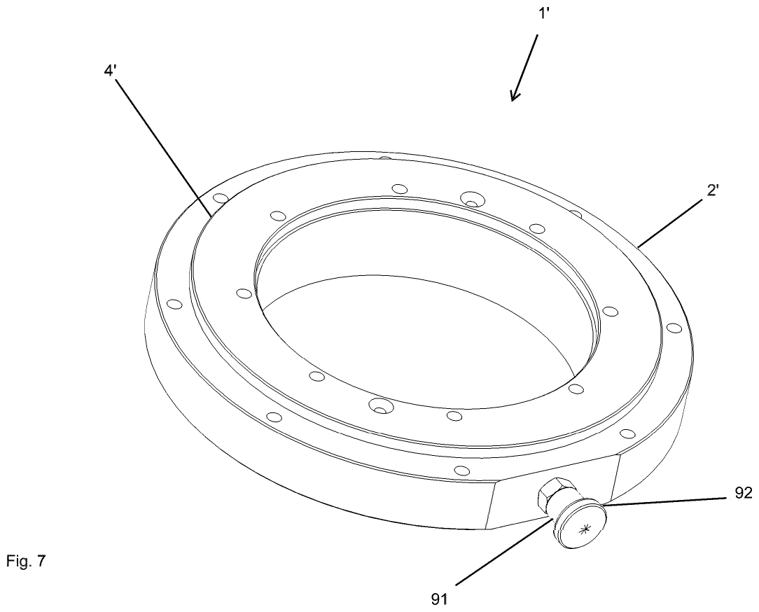

FIG. 7 is a perspective view of an axial-radial sliding bearing of a second embodiment designed according to the invention,

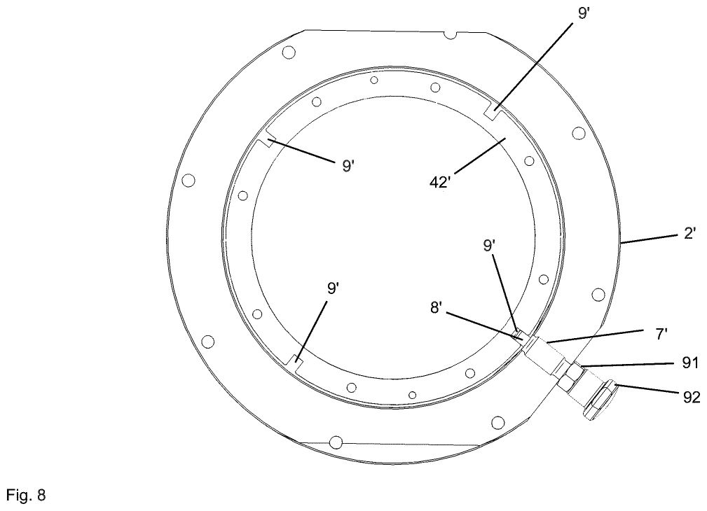

FIG. 8 shows a sectional view of the axial-radial sliding bearing shown in FIG. 7 to illustrate an actuating element,

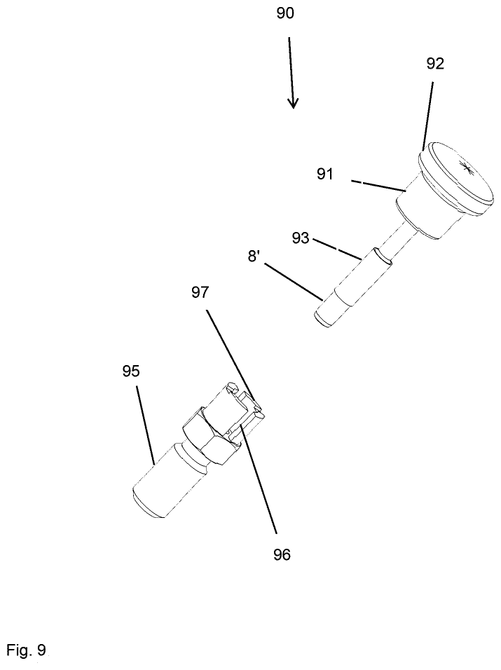

FIG. 9 shows an exploded view of components of the actuating element,

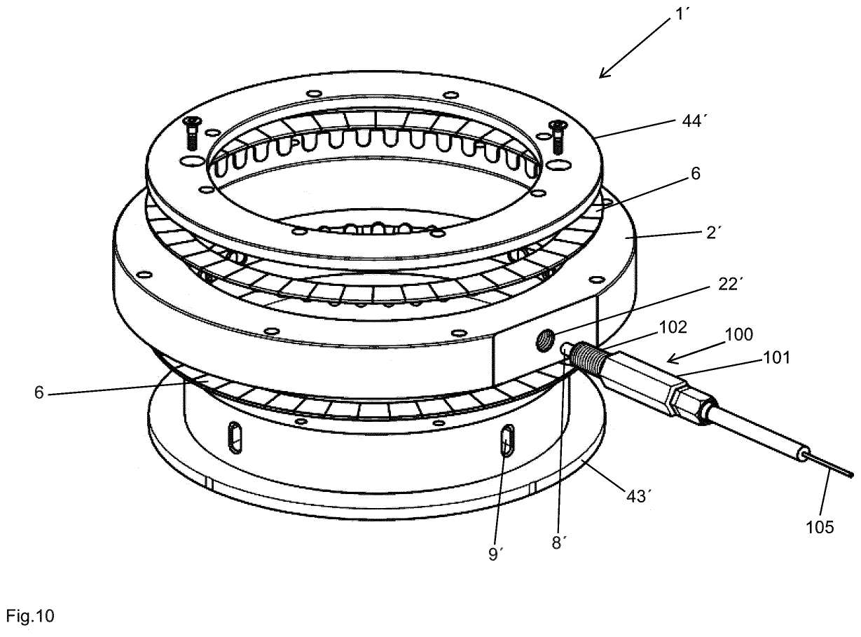

FIG. 10 is a perspective exploded view of an axial-radial sliding bearing of a third embodiment designed according to the invention,

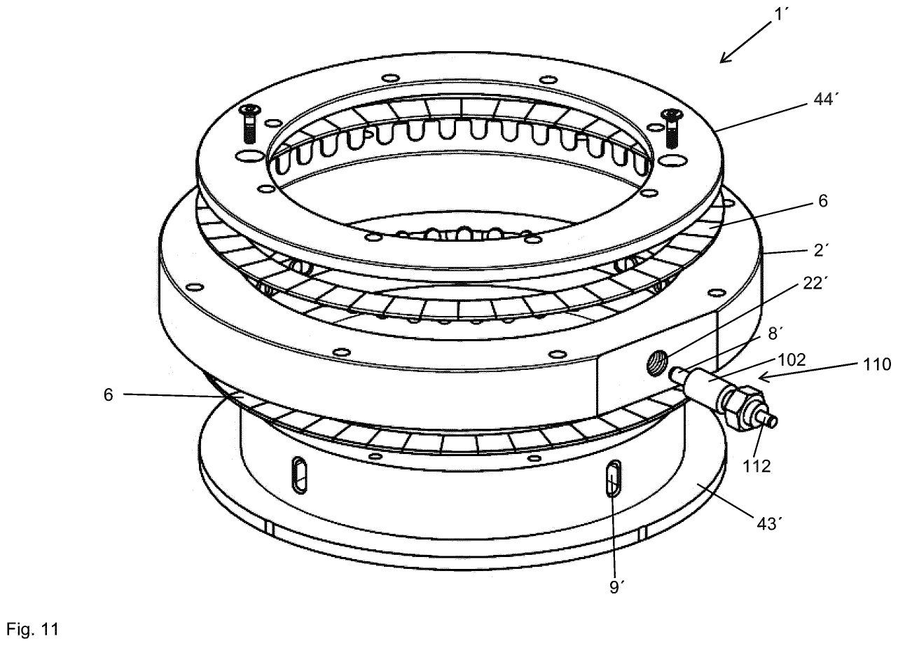

FIG. 11 is a perspective exploded view of an axial-radial sliding bearing of a fourth embodiment designed according to the invention, and

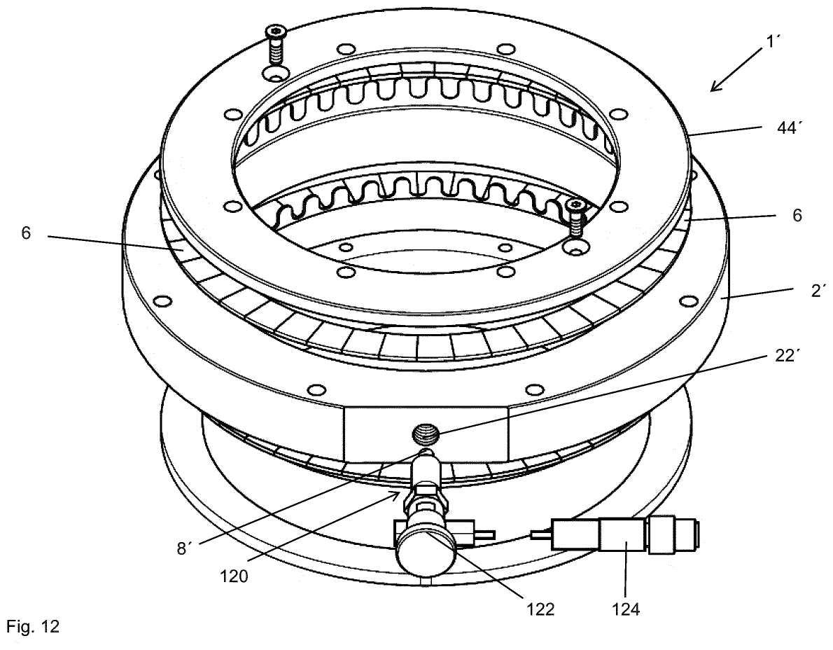

FIG. 12 is a perspective exploded view of an axial-radial sliding bearing of a fifth embodiment designed according to the invention.

In FIG. 1, an axial-radial sliding bearing 1 according to the invention is shown in a perspective view. The bearing 1 has a first or inner bearing ring 2 that is arranged coaxially with a second or outer bearing ring 4 and is received by the latter over its entire axial extent and over a section of its radial extent. For this purpose, the second bearing ring 4 is approximately U-shaped in a section that encompasses the longitudinal axis of the sliding bearing. Both bearing rings 2, 4 can be formed from a same or different metal material such as aluminum or steel. However, it is also possible to form at least one of the bearing rings or both of them from a plastic material, in particular at least in sections.

In the embodiment shown, the first bearing ring 2 is formed in one piece in the manner of a hollow cylinder with a low overall height, while the second bearing ring 4 is composed of two ring sections 41 a, b that are axially spaced and connected by means of an axial flange 42 to form the described ring with a U-shaped cross section. L-shaped sliding elements 6 are provided between mutually facing radial and axial surfaces of the two bearing rings 2, 4 for decoupling or removing the friction between the bearing rings at the mutually facing axial and radial surfaces. The dimensions of the axial height of the first bearing ring, including the thickness of the sliding elements 6, are adapted to the axial spacing of the ring sections 41 a, b of the second bearing ring or its receptacle in such a way that the two bearing rings 2, 4 are arranged so as to be rotatable to each other essentially without play or with a small gap dimension about the axis A of the sliding bearing. Depending on the application, the axial-radial sliding bearing according to the invention can be used in such a way that the first bearing ring or the second bearing ring is arranged in a stationary manner, while the respective other bearing ring is rotatable relative to the first-mentioned.

FIG. 2 shows the axial-radial sliding bearing of FIG. 1 in a sectional view, the sectional plane comprising the bearing axis A. As can be seen, in the embodiment described, the second bearing ring 4 is formed by an L-shaped ring 43 which provides a ring section 41b and an axial flange 42, to the free end of which a ring 44 is attached, so that the radial surface 45 and the two axial surfaces 40 a, b of the L-shaped ring 43 or of the ring 44 form a receptacle for the first bearing ring 2. As can be seen, the axial surfaces 20 a, b of the first bearing ring face the axial surfaces 40 a, b of the second bearing ring, and in a corresponding manner the radial surface 45 of the second bearing ring and the radial surface 21 b of the first bearing ring face each other, with sliding elements 6 being arranged therebetween with corresponding sector sections parallel to the indicated axial and radial surfaces of the two bearing rings, in order to enable the two bearing rings to rotate against each other with as little friction as possible.

FIG. 3 shows the axial-radial sliding bearing 1 designed according to the invention in a frontal plan view, in which the ring 44 screwed to the L-shaped ring 43 to form the second bearing ring 4 has been removed. In this respect, FIG. 3 shows a frontal view of the axial surface 20a of the first bearing ring 2 on which a plurality of sliding element sectors 60 are arranged in the axial overlap region of the first bearing ring 2 with the second bearing ring 4 to provide axial sliding surfaces. For adjusting the respective curvature, the sliding element sectors 60 extending circumferentially and radially are formed in a trapezoidal shape so that a slot 61 is located between adjacent sectors. The sliding element sectors 60 completely cover the radially inner section of the axial surface 20a except for an angular section in which a seat 7 for a detent element 8 is arranged in the first bearing ring 2. In the embodiment described, the locking of the two bearing rings arranged rotatably to each other takes place on the respective mutually facing radial surfaces of the two bearing rings 2, 4. In this case, the detent element is designed here as a cylindrical pin which is arranged under spring load in an approximately rectangular recess adapted to the diameter of the detent element. In this respect, this recess acts as a seat 7 for the detent element 8, the relative position of the detent element within the seat depending on the respective relative rotational state of the two bearing rings 2, 4 with respect to each other. As shown, the seat has a substantially cuboid shape or recess, wherein the bottom portion, i.e. the radial boundary portion, may be curved, in particular adapted to the curvature of the detent element 8.

In the embodiment described, the detent element 8 is subjected to force in the radial direction by means of a spring element 80, here in the form of a spiral spring, the spring element being supported on a fastening element, for example a radially arranged screw 81, see FIG. 1. The relative rotational position of the two bearing rings 2, 4 indicated in FIG. 3 results in a locking action of the two bearing rings to each other, since in the indicated relative rotational position the detent element 8 is pressed into a detent recess 9 associated therewith due to the application of force, so that the free rotatability of the bearing rings to each other is blocked. It can be seen that the radial surface 45 of the axial flange 42 has four detent recesses 9 spaced circumferentially by 90° and adapted to the cylindrical shape of the detent element 8, so that during a full rotation the four detent positions defined as described can be approached in a defined manner.

As shown, in the region of the seat 7 for the detent element 8 on the axial surface 20a, no sliding element sector of one of the described sliding elements for providing a corresponding axial sliding surface section in trapezoidal form is provided, but instead two additional sliding elements 5 are provided, which are rod-shaped in this case and which each extend with their front face out of their associated axially extending bore in the first bearing ring and flush with the sliding element sectors 60 of the sliding elements 6.

FIG. 4 shows the second bearing ring in a perspective oblique view of the radial surface 45 as well as one of the detent recesses 9, which in the described embodiment extends over the entire axial spacing between the two ring sections 41a, b and is thus adapted to the axial length of the detent element 8. The four detent positions provided in the described embodiment of the axial-radial sliding bearing according to the invention correspond to four relative rotational positions of the two bearing rings 2, 4 to each other and can be resolved by applying a torque above a predetermined threshold, the resolution here being set symmetrically, i.e., independently of the direction of rotation, due to a symmetrical design of the detent surfaces of the detent element and the associated detent recess or recesses.

FIG. 5 shows an oblique view of the first bearing ring 2 of the axial-radial sliding bearing 1 according to the invention in a single view. There can be seen the radially inner radial surface 21b facing the radial surface 45 of the second bearing ring, on which radial surface 21b the seat 7 is formed as a recess adapted to the detent element 8. A radial bore 22, starting from the outer radial surface 21a, penetrates through the seat approximately axially centrally and receives the spring element 80 and the support screw 81 in the assembled state. As shown in FIG. 4, the seat extends axially over the entire thickness of the first bearing ring 2.

FIG. 6 shows in a cut-out and in a single representation sliding elements 6 for the design of the axial-radial sliding bearing 1 according to the invention. In the embodiment described, two rows of identically constructed sliding elements 6 are used, in which case a single sliding element provides an axial sliding element sector 60 and a radial sliding element sector 64. In the embodiment described, the axial sliding element sectors are trapezoidal in shape, with both sectors 60, 64 being arranged at an angle of approximately 90° to each other to form an approximately L-shaped sliding element. For this purpose, each sliding element 6 has a film hinge 65 that can be formed by thinning the material in this area. In this case, in this embodiment, a first row of sliding elements 6 is arranged circumferentially in succession in the region of the radial inner section of the first bearing ring 2, so that the axial surface 20a can be occupied by the axial sliding element sectors 60 and the inner radial surface 21b can be occupied by the radial sliding element sectors 64 of the sliding elements 60, see FIG. 5. In addition to this first row of sliding elements, a further row of sliding elements 6 with sliding element sectors 60 is arranged in the same manner on the axial surface 20b of the first bearing ring 2 which is located at the bottom in FIG. 5, the corresponding radial sliding element sectors 64 in turn bearing against the inner radial surface 21b of the first bearing ring 2 for axial and radial decoupling of the bearing rings 2, 4 in the assembled state of all components of the axial-radial sliding bearing.

As can be seen from FIG. 6, the arrangement may be such that the radial sliding element sectors 64 of the two rows of sliding elements abut end-to-end such that twice the dimension of the sliding element sectors 64 in the radial direction is substantially equal to the thickness of the first bearing ring 2. As can be seen, the sliding element sectors 64 of the sliding elements are formed in such a way that by an offset of both rows of sliding elements by half the circumferential extent of a sliding element in the region of the film hinge 65, the sliding element sectors 64 engage each other such that the inner radial surface 21 of the inner bearing ring 2 is substantially completely covered by the sliding element sectors 64 and such that in this embodiment the axial thickness of the first bearing ring 2 substantially corresponds to the axial extent of a sliding element sector 64 in the axial direction in the installed position.

In a further embodiment, which is not illustrated, it may be provided that all sliding elements of the two circumferential rows of sliding elements indicated in FIG. 6 are connected to each other, in particular in the region of the film hinges 65. Such a link chain of sliding elements can also be produced in a simple manner, for example, by an injection molding process.

The skilled person will recognize that other geometrical designs of the sliding element sectors 60, 64 are also possible, depending on the respective application or on the operating forces that occur.

With reference to FIGS. 7 to 9, a second embodiment of an axial-radial sliding bearing 1′ according to the invention is described below, wherein FIG. 7 shows the sliding bearing 1′ in a perspective view which, with respect to the design and relative arrangement of the first and second bearing rings and the sliding elements arranged therebetween and with respect to further details such as the basic design and arrangement of the detent element and the at least one detent recess associated therewith, are identically designed to the embodiment described with reference to FIGS. 1-6. For this reason, only the differences of these second embodiments will be discussed below with reference to the Figures.

The sliding bearing 1′ of FIG. 7 has an actuating element 91 as part of an actuating device 90, which actuating element in the embodiment described comprises an actuating section 92 that is operatively connected, here motion-coupled, to a detent element or detent section 8′, see FIG. 8, in which the axial-radial sliding bearing 1′ of FIG. 7 according to the invention is shown in a sectional view perpendicular to the axis and with view to the cut-free actuating element 92. This sectional view also shows the detent recesses 9′ arranged on the axial flange 42′ of the second bearing ring 4′, which in this embodiment may be of identical design to the detent recesses 9 of the embodiment described with reference to FIGS. 1 to 6. In this case, the same extends over the entire axial extent of the axial flange 42′. In an embodiment not shown, these detent recesses 9′ can also be cylindrical in shape and in this respect do not extend over the entire axial extent of the axial flange 42′, so that in this embodiment the recesses can be designed to be axially closed. As shown in FIG. 8, the actuating element 91 can have, in addition to the actuating section 92, a detent element 8′ which is arranged here integrally with the latter and can be designed in this embodiment as a pin-like cylinder whose circumferential extent is adapted to the circumferential extent of the associated detent recesses 9′, in order to avoid circumferential play between the first and second bearing rings (2′, 4′) after the locking has been set. It can be seen that the seat 7′ associated with the detent element 8′ is essentially formed as a radial passage in the first bearing ring 2′, in which passage a fastening sleeve 95 of the actuating element 91 is arranged, see FIG. 9, which is an exploded view of the actuating device 90. In addition to the fastening sleeve 95, the actuating device 90 has an actuating element 91 which is of elongated design here and has the detent element 8′ at a first end and an actuating section 92 at the opposite end, both end sections of the actuating element being rigidly connected to each other by a connecting section 93.

In the assembled state, the actuating element 91 extends through the fastening sleeve 95 and is supported with respect to the latter by means of a spring (not shown) in such a way that the actuating element 91 and thus its detent element or detent section 8′ is subjected to force radially inwards relative to the two bearing rings, so that in a predetermined rotational position of the two bearing rings to each other, in which the detent element 8′ of the actuating element 91 is situated radially opposite one of the detent recesses 9′, the actuating element 91 with its detent element or detent element section 8′ comes into engagement with the respective detent recess 9′.

A detent release, i.e., a disengagement of the detent section of the actuating element 91 with a respective detent recess 9′, takes place by pulling the actuating section 92 radially outward. In order to avoid the actuating element 91 having to be permanently pulled outwards when setting a further assembly position or a further relative position of the two bearing rings to each other, the actuating device 90 has a functionality for locking an operating position in which locking exists between the detent element and one of the detent recesses. For this purpose, in the embodiment described, the fastening sleeve 95 has a guide slot 96 extending radially to the bearing rings, which guide slot 96 cooperates with a radial projection in the region of the actuating section 92, which projection is concealed in FIG. 9, for radially forced guidance of the actuating element 91 with respect to the fastening sleeve 95. In such an operating position, in which the actuating element 91 and/or the projection guided by the guide slot 96 disengages from the guide slot 96, the actuating element 91 is arranged for rotation relative to the stationary fastening sleeve 95, so that the guide pin arranged on the actuating element 91 becomes radially positively locked with the front wall 97 of the fastening sleeve 95, so that the actuating device 90 is locked. This locking can be released by turning the actuating element back to the initial position, in which the radial positive locking is released and the guide pin engages with the guide slot 97 again, so that the actuating element is pressed radially inwards onto the detent element 8′ and thus onto the actuating element as a result of the spring force load as long as no force counteracting the spring force load is introduced into the system via the actuating section 92.

The following FIGS. 10 to 13 show different axial-radial sliding bearings 1′, which do not differ from the embodiment of the FIGS. 7 and 8 with respect to the design and arrangement of the first bearing ring 2′, the second bearing ring 4′ and the sliding elements 6 as well as the seat 7′, but solely with respect to the design of the actuating device 100, 110, 120, which will be discussed below.

In the embodiment of FIG. 10, the actuating device 100 comprises a rod-shaped housing 101 which is designed as a threaded sleeve 102 at its front side end facing the detent element 8′, via which sleeve the actuating device 100 can be screwed into the threaded bore 22′ of the first bearing ring 2′. In this embodiment, the detent element 8′ is connected to an actuating section (not illustrated in the Figure), which can be actuated in particular manually, via a pulling means designed as a Bowden cable 105. For example, an actuating section of the actuating device arranged remotely from the actual sliding bearing comprising the two bearing rings can be provided, such as an actuating lever, via which a pulling force can be applied to the Bowden cable 105 in order to release a detent position between the first and second bearing rings 2′, 4′. For this purpose, the Bowden cable 105 is motion-coupled to the detent element 8′, e.g., fixed to the latter directly or with the interposition of at least one further component.

In the embodiment of an axial-radial sliding bearing designed according to the invention as shown in FIG. 11, the actuating device 110 has on its housing a threaded sleeve 102 facing the detent element 8′ with which the device 110 can be screwed into the associated threaded bore 22′ of the first bearing ring 2′. The detent element 8′ is in turn arranged movably in a radial direction with respect to the housing of the actuating device 110 and, in the embodiment described, is rigidly connected to a coupling bolt 112 which protrudes from the front side of the housing of the actuating device 110 facing away from the detent element. In this respect, in the embodiment described, the coupling bolt 112 with the detent element 8′ in an installation position is arranged so as to be movable in the radial direction with respect to the housing of the actuating device 110 or with respect to the first bearing ring. This embodiment of an axial-radial sliding bearing designed according to the invention is particularly suitable for connection to a user-specific adjusting unit not shown in FIG. 11, which can be coupled to the threaded coupling bolt 112 simply be screwing, because the adjusting unit has a complementary coupling part in the form of a female thread.

In the embodiment of FIG. 12, the actuating device 120 has an adjusting unit 122 which can be electrically actuated and which comprises, as a monitoring device, an electrical monitoring contact in which a contact surface is motion-coupled on the output side to the adjusting unit for indicating a respective locking state and/or a locking release state of the sliding bearing. In the embodiment described, the adjusting unit is in the form of an electric cylinder, the electric cylinder having a housing to which the detent element 8′ is slidably arranged and which comprises a threaded sleeve 102 by which the actuating device 120 or the adjusting unit 122 can be screwed into the associated threaded bore 22′ of the first bearing ring. In the described embodiment, the adjusting unit 122 is provided with an integrated energy source, such as a rechargeable battery, so that the adjusting unit does not require an external energy source. In order to control the adjusting unit and/or to transmit a detected operating state via the described monitoring contact, the actuating device 120 comprises, in addition to the adjusting unit 122, a transceiver module 124 which is galvanically and mechanically coupled to the latter and, in particular, communicates wirelessly with an external control device. For example, control signals for controlling the adjusting unit can be transmitted to the adjusting unit via the transceiver module 124, and/or detected operating states of the locking and/or non-locking between the two bearing rings 2′, 4′ or a number of detected changes in the operating state can be communicated to an external control device.

### LIST OF REFERENCE SIGNS

1, 1′ axial-radial bearing
2, 2′ first bearing ring
4, 4′ second bearing ring
5 sliding element
6 sliding element
7, 7′ seat
8, 8′ detent element
9, 9′ detent recess
20a, b axial surface
21a outer radial surface
21b inner radial surface
22, 22′ bore
40a, b axial surface
41a, b ring section
42, 42′ axial flange
43 L-shaped ring
44, 44′ ring
45 radial surface
46 fastening screw
60 sliding element sector of axial surface; first sector
61 slot
64 sliding element sector of axial surface; second sector
65 film hinge
80 spring element, spring
81 supporting screw
90 actuating device
91 actuating element
92 actuating section
93 connecting section, force-transmitting section
95 fastening sleeve
96 guide slot
96
97 front wall
100, 110, 120 actuating device
101 housing
102 threaded sleeve
105 Bowden cable
112 coupling bolt
122 adjusting unit with integrated monitoring contact
124 transceiver module
A rotation axis

1. An axial-radial sliding bearing (1) comprising
a first bearing ring (2);
a second bearing ring (4), the bearing rings being arranged rotatably against each other about a bearing axis (A), and the second bearing ring (4) forming a substantially U-shaped cross-section to accommodate the first bearing ring (2) at least in sections; and,
sliding elements (6) made of a polymer material, which are arranged between the first and second bearing rings in order to decouple the bearing rings axially and radially, the sliding elements (6) each having a substantially L-shaped cross-section with an axial region comprising axial sliding surfaces and a radial region comprising radial sliding surfaces, and
wherein at least one of the two bearing rings has a seat (7) for a force-loaded and deflectable detent element (8) accommodated therein, and the other of the two bearing rings comprises at least one detent recess (9) associated with the detent element for accommodating the deflectable detent element (8) at least in sections in order to provide a releasable locking action at a specified relative rotational position of the two bearing rings (2, 4) to each other,
wherein
i) the axial-radial sliding bearing (1) is configured in such a way that a releasing torque for releasing the locking of the two bearing rings (2, 4) to each other by applying a predetermined torque to one of the two bearing rings (2, 4) can be generated, while the other of the two bearing rings (2, 4) is held stationary, said predetermined torque representing a torque threshold from which the locking is releasable,
and/or
ii) the first bearing ring (2) is accommodated by the second bearing ring (4) over its entire axial extent and over a section of its radial extent, the detent element (8) and the detent recess (9) being arranged on mutually facing interfaces of the two bearing rings (2, 4).

2. The axial-radial sliding bearing (1) according to claim 1, wherein the detent element (8) and the at least one detent recess (9) associated therewith are arranged on respective mutually facing radial surfaces (21b, 45) of the one and the other bearing ring and in that the detent element (8) arranged in the seat (7) of the one bearing ring is subjected to force in the radial direction and can be deflected.

3. The axial-radial sliding bearing (1) according to claim 1, wherein the detent element (8) has, at least in sections, a spherical or cylindrical detent surface which in a detent position of the detent element (8) relative to the at least one detent recess (9) corresponds with a detent surface of the detent recess which is of complementary design, at least in sections.

4. The axial-radial sliding bearing (1) according to claim 1, wherein the second bearing ring (4) has two axially spaced ring sections (41a, b) which are connected by an axial flange (42), the first bearing ring (2) being arranged between the two axially spaced ring sections (41a, b) of the second bearing ring (4), at least in sections.

5. The axial-radial sliding bearing (1) according to claim 1, wherein the detent element (8) is formed in one or more pieces and extends over more than half of the axial dimension of the bearing ring with the smaller axial extent.

6. The axial-radial plain bearing (1) according to claim 1, wherein a spring (80) is provided for providing a force application to the detent element (8), which spring (80) is arranged in a bore (22) of one of the two bearing rings and is clamped between the detent element (8) and a radial stop element.

7. The axial-radial sliding bearing (1) according to claim 1, wherein the other of the two bearing rings has a plurality of circumferentially spaced detent recesses (9) for successively receiving the detent element (8) at a rotation of the two bearing rings (2, 4) to each another.

8. The axial-radial sliding bearing (1) according to claim 1, wherein the seat (7) for the detent element (8) on the one of the two bearing rings is designed for substantially, completely accommodating the detent element in relative operating positions of the two bearing rings (2, 4) to each another outside a detent position.

9. The axial-radial sliding bearing (1) according to claim 1, wherein the at least one detent recess (9) is arranged on the second bearing ring (4) and the seat (7) of the detent element is arranged on the first bearing ring (2).

10. The axial-radial sliding bearing (1′) according to claim 1, wherein an actuating device (90) is arranged on one of the two bearing rings, the actuating device having an actuating section (92) which can be moved with respect to this bearing ring (2′) and is operatively connected to the detent element (8′).

11. The axial-radial sliding bearing (1′) according to claim 10, wherein the actuating device (90) is arranged and designed to exert, via the actuating section (92), a counteracting force on the detent element (8′) for subjecting the detent element to a force for releasing the locking of the detent element (8′) from the at least one detent recess (9′).

12. The axial-radial sliding bearing (1′) according to claim 10, wherein the actuating section (92) of the actuating device is arranged to be radially deflectable relative to the one of the two bearing rings.

13. The axial-radial sliding bearing (1′) according to claim 10, wherein the detent element (8′) and the actuating section (92) are in operative connection via a force-transmitting element or section of the actuating device (90).

14. The axial-radial sliding bearing (1′) according to claim 10 wherein the actuating device (90) is arranged and designed for locking an operating position in which a locking of the detent element (8′) in the at least one detent recess (9′) is released.

15. The axial-radial sliding bearing (1′) according to claim 14, wherein, the actuating section (92) is arranged for a forcibly guided movement in the radial direction relative to one of the two bearing rings (2′, 4′) over a predetermined distance threshold to release the locking starting from a locking position of the detent element (8′), and is arranged for rotation about a radial direction after exceeding the distance threshold to set a radial positive locking between the actuating section (92) and said one of the two bearing rings (2′).

16. The axial-radial sliding bearing (1) according to claim 1, wherein a material thinning in the manner of a film hinge (65) is provided between the radial and axial sliding surfaces of the respective sliding elements (6) for bending the radial to the axial sliding surfaces of a sliding element (6) by approximately 90°.

17. The axial-radial sliding bearing (1) according to claim 1, wherein a sliding element (6) comprises in the region of its axial sliding surfaces a plurality of first sectors (60) arranged essentially without gaps and succeeding each other circumferentially, while the sliding element (6) comprises in the region of its radial sliding surfaces a plurality of second sectors (64) arranged spaced from each circumferentially and succeeding each other circumferentially.

18. The axial-radial sliding bearing (1) according to claim 1, wherein at least two sliding elements (6) are comprised which in the installed position are axially offset with respect to their axial sliding surface by approximately the axial dimension of the first bearing ring (2) and, in particular, are circumferentially offset with respect to each other by approximately half the circumferential dimension of the first sectors (60).

19. The axial-radial sliding bearing (1) according to claim 1, wherein the actuating device has a controllable actuator for non-manually adjusting and/or releasing the engagement of the detent element in the at least one detent recess.

20. The axial-radial sliding bearing (1) according to claim 10, wherein the actuating section has a mechanical coupling device.

21. The axial-radial sliding bearing (1) according to claim 1, further comprising a monitoring device for detecting locking and/or non-locking states of the axial-radial sliding bearing (1).
